(19) United States
(12) Patent Application Publication
(10) Pub. No.: US 2026/0310604 A1
(43) Pub. Date: Oct. 8, 2026

(54) DYNAMIC MODIFICATION OF GLOBAL CACHE CAPACITY

(71) Applicant: Hewlett Packard Enterprise Development LP, Spring, TX (US)

(72) Inventors: Clarete Riana Crasta, Bangalore (IN); John L. Byrne, Pasadena, CA (US); Abhishek Dwaraki, Pearland, TX (US); David R. Emberson, Santa Cruz, CA (US); Harumi Kuno, Cupertino, CA (US); Sekwon Lee, Austin, TX (US)

(21) Appl. No.: 19/242,591

(22) Filed: Jun. 18, 2025

Related U.S. Application Data
(60) Provisional application No. 63/785,456, filed on Apr. 8, 2025.

(51) Int. Cl. G06F 12/084

(52) U.S. Cl. CPC G06F 12/084; G06F 2212/1041; G06F 2212/6042

(57) ABSTRACT

One aspect provides a system for dynamically adjusting capacity of a distributed global cache. A cache-manager process running on a respective node may monitor the usage of the global cache and determine whether capacity of the global cache needs adjustment based on the monitored usage. In response to determining that the global cache needs additional capacity, the system may identify a first node capable of providing the additional capacity, send an add-capacity request to the first node, and add a portion of storage resource on the first node to the global cache. In response to determining that the global cache needs to reduce capacity, the system may identify a second node that contributes to the global cache, send a reduce-capacity request to the second node, and remove, from the global cache, at least a portion of storage resource contributed by the second node.

### RELATED APPLICATION

This application claims the benefit of Provisional Application No. 63/785,456, Attorney Docket Number HPE-P176905USPRV, entitled “DYNAMIC MODIFICATION OF GLOBAL CACHE CAPACITY,” by inventors Clarete Riana Crasta, John L. Byrne, Abhishek Dwaraki, David R. Emberson, Harumi Kuno, and Sekwon Lee, filed 8 Apr. 2025.

### BACKGROUND

High-performance computing (HPC) and artificial intelligence (AI) workloads demand efficient management of petabyte-scale data, where file system access latency plays a critical role in overall performance. Distributed workloads, in particular, rely on centralized storage systems to share intermediate results across nodes, making these workloads especially sensitive to storage latency. To mitigate these challenges, modern file systems employ various caching strategies, including server-side and client-side caching. Server-side caching stores frequently accessed data in high-speed memory on the file servers, but is limited by the server's memory capacity and network bandwidth. Client-side caching stores frequently accessed data locally, which can reduce access times for repeated reads. However, traditional client-side caching typically restricts data reuse to the local node, limiting the benefits of cache sharing across the entire cluster.

### BRIEF DESCRIPTION OF THE FIGURES

FIG. 1 illustrates a computer cluster implementing a global cache, according to one aspect of the instant disclosure.

FIG. 2 illustrates a functional block diagram of a cache manager, according to one aspect of the instant disclosure.

FIG. 3 illustrates a functional block diagram of a global-cache memory manager, according to one aspect of the instant disclosure.

FIG. 4 illustrates a process for initializing a global cache, according to one aspect of the instant application.

FIG. 5A illustrates a process for increasing the capacity of a global cache, according to one aspect of the instant application.

FIG. 5B illustrates a process for decreasing the capacity of a global cache, according to one aspect of the instant application.

FIG. 6 presents a flowchart illustrating an example process for modifying the capacity of a global cache, according to one aspect of the instant application.

FIG. 7 illustrates a computer system for facilitating the dynamic adjustment of the global cache capacity, according to one aspect of the instant disclosure.

FIG. 8 illustrates a computer-readable medium (CRM) that facilitates dynamic adjustment of the global cache capacity, according to one aspect of the instant disclosure.

In the figures, like reference numerals refer to the same figure elements.

### DETAILED DESCRIPTION

Existing cache systems are typically tailored for specific use cases, such as application, file system, or object store acceleration, which often lead to fragmented resource allocation when handling heterogeneous workloads.

To address the challenge of supporting diverse data-access requirements, the present disclosure introduces a client-side multi-tiered global cache system that leverages a wide range of memory and storage technologies, including High Bandwidth Memory (HBM), Storage Class Memory (SCM), Non-Volatile Memory Express (NVMe) drives, and traditional Dynamic Random-access Memory (DRAM). This global cache may be persistent and shared across multiple applications and workloads within a computer cluster. Furthermore, to accommodate the dynamically changing compute, memory, and storage demands of different applications, the capacity of the global cache may be adjusted dynamically, ensuring optimized resource utilization and system performance.

As the number of compute nodes in an HPC cluster increases, the total resources available for client-side caching, such as DRAM capacity and network bandwidth, grow proportionally. Providing a shared client-side cache across multiple nodes becomes increasingly advantageous for optimizing data access and reducing redundant storage. According to some aspects of the instant disclosure, the client-side global cache may aggregate diverse storage resources (e.g., DRAM, NVMe, HBM, and SCM) contributed by multiple nodes within the cluster, including both the compute nodes and dedicated memory-server nodes.

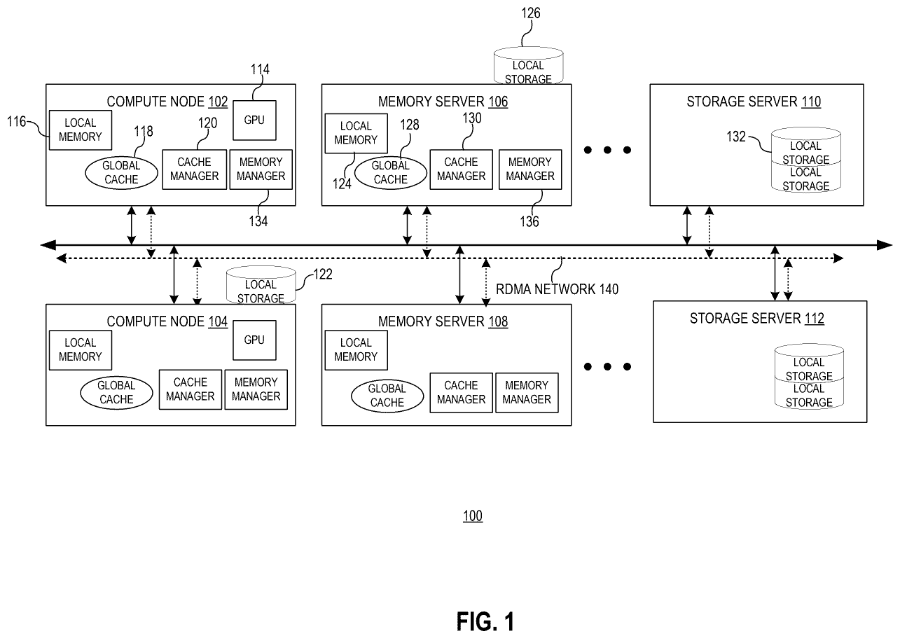

FIG. 1 illustrates a computer cluster implementing a global cache, according to one aspect of the instant disclosure. In this example, a computer cluster 100 may include a plurality of interconnected nodes, such as compute nodes 102 and 104, memory servers 106 and 108, and storage servers 110 and 112.

A compute node may include a dedicated server optimized for executing computational tasks (e.g., data processing, simulation, or application execution). A memory server may include a specialized server designed to provide large, shared memory pools (e.g., distributed DRAM or SCM) to other nodes in the cluster. The compute nodes and memory servers in the cluster may include different types of storage resources, including but not limited to: persistent memory (e.g., Non-Volatile Dual In-line Memory Modules (NVDIMM) and SCM), SSDs, DRAM, GPU memory (e.g., HBM), and any type of computer-readable storage medium that can offer high data access speeds. “A storage resource” may include memory, disk space, or storage devices (such as HDDs, SSDs, or NVMe drives) available on a specific node within the cluster.

Different types of storage resources may be organized into multiple tiers, with the top tier providing the highest speed. In one example, the top tier (or Tier 1) may include DRAM and GPU memory, the second tier (or Tier 2) may include persistent memory like SCM and NVDIMM, the third tier (or Tier 3) may include SSDs, and the bottom tier (or Tier 4) may include large-capacity persistent storage (e.g., hard drives). In a further example, each type of storage resource may correspond to a distinct tier within the cache. The storage resources may be used to store instructions, data, application files, temporary files, logs, backups, and any information related to the operations of the node.

In the example shown in FIG. 1, compute node 102 includes a GPU 114 and local memory 116. Compute node 102 may contribute a portion of local memory 116 to the global cache, and this contribution is represented as a global-cache portion 118 residing on compute node 102 in FIG. 1. Compute node 104 is similar to compute node 102 but includes an extra local storage module 122, which may include SSDs. Compute node 104 may contribute a portion of its local memory and/or local storage module 122 to the global cache. In some examples, spaces within local storage module 122 (e.g., local SSDs) may function as a spillover area when the global cache exhausts its DRAM capacity. SSDs offer a good balance between the high-speed, limited-capacity DRAM (i.e., the top tier) and the larger-capacity parallel distributed persistent storage tier (i.e., the bottom tier). By leveraging the fast parallel I/O of SSDs, frequently accessed data may be stored and retrieved with reduced latency, enhancing computational throughput. Incorporating local SSDs in the global cache also improves cost efficiency, as SSDs offer a lower per-byte cost than DRAM while delivering performance that approaches memory speeds.

Memory server 106 includes local memory 124 and a local storage module 126. Memory server 106 may contribute a portion of local memory 124 and/or local storage module 126 to the global cache, and this contribution is represented as a global-cache portion 128 residing on memory server 106. Memory server 108 is similar to memory server 106. It includes a local memory but lacks a local storage module. Memory server 108 may also contribute a portion of its local memory to the global cache.

Storage servers are designed to store, manage, and provide access to large amounts of data and are built with large storage capacities, often using a plurality of SSDs and hard drives (HDs). In the examples shown in FIG. 1, storage servers 110 and 112 each include an array of local storage modules (e.g., module 132). The storage servers may provide a distributed object store (e.g., Distributed Asynchronous Object Storage (DAOS) or a distributed file system.

The global cache may support high-speed data movement within and across applications via a remote direct memory access (RDMA) network 140, which provides low-latency memory access. As discussed previously, when the DRAM capacity from various nodes is exceeded, the global cache may seamlessly offload data to locally connected SSDs, reducing overall DRAM requirements while maintaining performance.

The global cache may function as an application cache, allowing data processed by one application to remain in the cache for use by other applications, which improves efficiency and reduces redundant data movement. Additionally, the global cache may also operate as a file system or object store cache with minimal modifications. Different cache policies may be implemented based on the configuration of the global cache. The global cache is also compatible with various file systems, such as DAOS or the Lustre file system, both of which support unified namespace integration and seamless data access across storage tiers. This flexibility allows the global cache to serve as a unified resource for applications running across the cluster.

When functioning as an application cache, the global cache may be shared across applications running on different nodes (e.g., compute nodes 102 and 104) within the cluster. The global cache may be partitioned, allowing fractions of its total cache capacity to be allocated to individual applications based on several factors such as target and measured Quality of Service (QoS) values, target and measured hit rates over specific time intervals. The applications' need for cache capacity may change dynamically as applications are added to or removed from the cluster, and requests for cached content from running applications may fluctuate. Cache partitioning facilitates dynamic allocation of cache capacity and helps ensure that cache resources are distributed in a way that optimizes overall utility and adapts to changing workload characteristics.

According to some aspects of the instant disclosure, the global cache may be managed by a distributed cache manager, which is responsible for consolidating the per-node resources of multiple tiers into a unified cache, maintaining awareness of the capacities and access latencies associated with each tier, and for implementing appropriate cache policies and data placement algorithms. Using the application cache as an example, the distributed cache manager may be linked with an application and be part of the application process running on each node where the application is running. The cache manager may be responsible for coordinating cache capacity and usage across different nodes (e.g., nodes 102-108) and memory/storage tiers (e.g., DRAMs and SSDs). The distributed cache manager may monitor cache usage, handle configuration changes, and dynamically adjust cache capacity to optimize performance and resource utilization. Moreover, to dynamically adjust the cache capacity, the distributed cache manager may interact with a global-cache memory manager running on each node that contributes to the global cache.

Each node contributing to the global cache may run a cache-manager process that manages the cache operations (e.g., data placement and eviction policies) and a global-cache-memory-manager process that manages the node's contribution to the global cache (e.g., memory allocation). In the example shown in FIG. 1, compute node 102 runs a cache-manager process 120 and a global-cache-memory-manager process 134, while memory server 106 runs a cache-manager process 130 and a global-cache-memory-manager process 136, with similar processes running on other nodes in the cluster.

The cache-manager processes running on different nodes may be synchronized via cache-manager metadata, which may be stored at a shared storage location accessible to all nodes running the cache-manager process. The cache-manager processes may be responsible for coordinating cache capacity and usage across different nodes (e.g., nodes 102-108) and different memory/storage tiers (e.g., DRAMs and SSDs). In addition, the cache-manager processes may monitor cache usage, handle configuration changes, and dynamically adjust cache capacity to optimize performance and resource utilization.

The global-cache-memory-manager process running on each node may be responsible for managing the portion of the local storage resource that the node contributes to the global cache. For instance, global-cache-memory-manager process 134 on compute node 102 manages global-cache portion 118, while global-cache-memory-manager process 136 on memory server 106 manages global-cache portion 128. According to some aspects, the global-cache-memory-manager process on a node may memory-map the address range of its memory contribution onto a temporary file storage system (tmpfs) to allow direct, low-latency access to cached data via virtual memory addresses. In addition, the global-cache-memory-manager process maintains the size of the memory-mapped region and allocates memory for cache segments (i.e., blocks of cached data) from this region.

To dynamically adjust the global cache capacity, the distributed cache manager may interact with the global-cache memory manager running on a compute node or memory server within the cluster to add or remove portions of local storage resources (e.g., DRAM, SCM, or SSDs) to or from the global cache. By continuously monitoring resource availability and workload demands, the distributed cache manager can scale the global cache in real time, ensuring optimal utilization and balanced performance across the cluster.

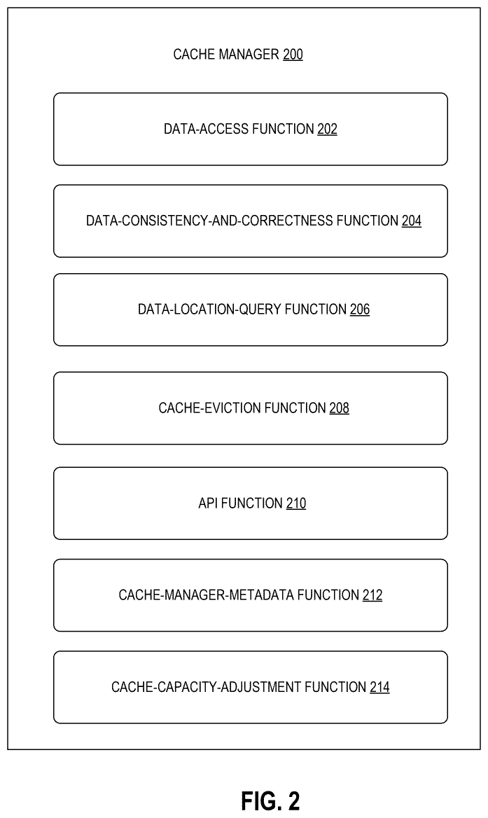

FIG. 2 illustrates a functional block diagram of a cache manager, according to one aspect of the instant disclosure. A cache manager 200 may include a data-access function 202, a data-consistency-and-correctness function 204, a data-location-query function 206, a cache-eviction function 208, an Application Programming Interface (API) function 210, a cache-manager-metadata function 212, and a cache-capacity-adjustment function 214. These functions may be implemented using software, hardware, firmware, or a combination thereof.

Data-access function 202 may employ various mechanisms to access data across different storage and memory tiers. For example, data-access function 202 may use operating system or file system interfaces to access data stored on SSDs, use RDMA to access data in CPU or GPU memory, and use native APIs to interface with distributed file systems (e.g., Lustre) or object stores (e.g., DAOS). Moreover, data-access function 202 may employ advanced data migration strategies to dynamically move data between memory and storage tiers based on real-time access patterns and application performance requirements. Frequently accessed data may be moved to faster memory tiers (e.g., DRAM or GPU memory), whereas less frequently used data may be moved to slower, more cost-effective storage tiers (e.g., SSDs or HDDs). When accessing the GPU memory, data-access function 202 may leverage GPUDirect capabilities (e.g., GPUDirect RDMA or GPUDirect Storage), where supported, for efficient data transfers between the GPU memory and the global cache.

According to some aspects, data-access function 202 may integrate and adapt functionalities developed for fabric-attached memory (FAM) systems (e.g., functionalities provided by the OpenFAM framework) into the caching layer. OpenFAM provides efficient access to network-attached (also referred to as “fabric-attached”) memory using RDMA over various high-performance networks, including Ethernet, Slingshot, and InfiniBand. Within the OpenFAM architecture, each node runs a memory manager responsible for managing its local memory contribution to the global FAM pool. Such a memory manager may be used to manage the local memory portion contributed to the global cache.

Data-consistency-and-correctness function 204 may be responsible for ensuring data consistency and correctness to allow the global cache to function according to the expected semantics of the underlying object store or file system. Data-consistency-and-correctness function 204 may enforce data consistency using mechanisms including, but not limited to, dirty bit tracking, cache invalidations, and metadata updates.

When the global cache is configured as an application cache, all data accesses may be handled by cache manager 200, obviating the need for invalidation since the cache manager has complete control over all data. However, when the global cache is configured as a file system cache, the underlying data may change due to external accesses outside the application or cache manager 200. In such cases, invalidation mechanisms are provided to maintain data consistency.

According to some aspects, data-consistency-and-correctness function 204 may provide invalidation mechanisms tailored to application requirements or the underlying storage system. More specifically, data-consistency-and-correctness function 204 may offer multiple configurable invalidation mechanisms, such as a mechanism to automatically invalidate cached data in response to notifications of changes in the underlying storage and a mechanism to invalidate cached data based on a Time-to-Live (TTL) policy, which ensures that stale data is periodically refreshed. These cache invalidation mechanisms ensure that the global cache operates according to the expected semantics of the object store or file system, providing reliable data access in heterogeneous and distributed environments.

Data-location-query function 206 may be responsible for responding to queries about the location of application data within the global cache. By providing accurate and up-to-date information about where specific data resides, data-location-query function 206 may allow compute tasks to be co-located with the corresponding data. Such data-aware scheduling may significantly reduce data movement, decrease access latency, and improve overall computational efficiency across the cluster.

Cache-eviction function 208 may be responsible for enforcing a wide range of flexible and configurable eviction policies, ranging from basic approaches such as Least Recently Used (LRU) and First-In-First-Out (FIFO) to advanced strategies like Adaptive Replacement Cache (ARC). Additionally, the system is designed to accommodate new policies in the future. Applications may specify the desired caching policy by leveraging configuration parameters or API calls.

API function 210 may be responsible for providing a plurality of APIs used to manage the global cache. These APIs may enable efficient data access, caching, and management across multiple nodes and memory or storage tiers. Examples of these APIs include, but are not limited to, object-management APIs, data-access APIs, metadata APIs, data-location APIs, and directory-management APIs.

The object-management APIs may include at least an open-object API (used to open an object in the global cache, retrieve its metadata, and initialize an object handle for subsequent operations), a close-object API (used to close an object, release associated resources, and update the cache state), and a delete-object API (used to delete an object from the cache and persistent storage, ensuring that all associated metadata and resources are cleaned up).

The data-access APIs may include at least a data-read API, a data-write API, and a preserve-data API. The data-read API may be used to read data from the global cache or underlying storage into a user-provided buffer. Cached data may be dynamically fetched from the appropriate tier (e.g., DRAM, SSD, or persistent storage) based on availability and access patterns. The data-write API may be used to write data to the global cache and update the appropriate memory tier and metadata. It ensures data consistency and handles block-level updates. The preserve-data API may be used to flush dirty data from the cache to persistent storage, ensuring data durability and consistency.

The metadata APIs may include a get-cache-configuration API (used to retrieve configurations of the global cache, including eviction policies, invalidation mechanisms, block size, and other parameters) and a set-cache-configuration API (used to set the configurations of the global cache).

The data-location APIs include a get-location API used to obtain information about the location of data blocks within the global cache. This data-location information may enable applications consuming the data to optimize access by co-locating computation with the data. For example, a task scheduler may use the get-location API to obtain the location information of data in the global cache and then schedule compute tasks accordingly. Compute tasks that require access to certain data are scheduled on nodes caching that data.

The directory-management APIs may include a make-directory API, used to create a directory in the persistent storage layer, and a remove-directory API used to remove a directory from the persistent storage layer.

The above-mentioned APIs are accessible to various frameworks utilizing the global cache, such as runtime systems or file system client components. APIs used to configure the global cache (e.g., selecting caching policies) may be user-visible. These APIs provide a robust framework for managing the distributed, multi-tiered global cache, enabling efficient data access, consistency, and scalability in heterogeneous HPC and AI environments. Moreover, the configurable APIs allow customization and integration of the global cache with various applications and storage systems, making it adaptable to a wide range of use cases and environments.

Cache-manager-metadata function 212 may be responsible for managing the cache-manager metadata, which may be stored at a shared location accessible to all nodes running the cache-manager process. The cache-manager metadata may include information regarding the contents of the global cache, such as data size and location. The cache-manager metadata may be updated each time a cache-manager process modifies the global cache (e.g., when new data is added to the cache or when changes are made to the cache capacity).

Cache-capacity-adjustment function 214 may be responsible for dynamically adjusting the capacity of the global cache based on the current cache usage of applications. Cache-capacity-adjustment function 214 may include a function for monitoring application usage of the global cache, a function for determining an appropriate node for adding or removing cache capacity, and a function for interacting with the global-cache memory manager on the selected node to add or remove a portion of the local storage resource to or from the global cache.

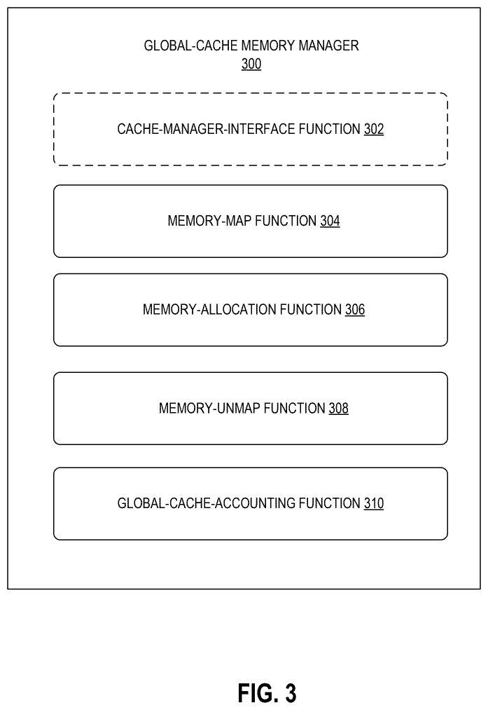

FIG. 3 illustrates a functional block diagram of a global-cache memory manager, according to one aspect of the instant disclosure. Global-cache memory manager 300 may include a cache-manager-interface function 302, a memory-map function 304, a memory-allocation function 306, a memory-unmap function 308, and a global-cache-accounting function 310.

Cache-manager-interface function 302 may be responsible for interfacing with the distributed cache manager. More specifically, it may interact with a cache-manager process running on the same node or on a different node. For example, cache-manager-interface function 302 may receive a query from the cache-manager process running on a specific node regarding the amount of local storage resource contributed to the global cache by that specific node. Cache-manager-interface function 302 may be optional.

Memory-map function 304 may be responsible for memory-mapping the local memory contribution (e.g., using the mmap system call to map the contributed portion) to processes, such as the cache-manager process on the corresponding node. In some examples, the local contribution may be memory-mapped onto a temporary file system (tmpfs), which stores all files and directories in volatile virtual memory and can grow dynamically as more space is needed.

Memory-allocation function 306 may be responsible for maintaining the size of the memory-mapped region and for allocating memory for cache blocks from the memory-mapped region. Memory-allocation function 306 may increase the size of the memory-mapped region when needed.

Memory-unmap function 308 may be responsible for unmapping (e.g., using the munmap system call) the local memory contribution that is no longer needed by the global cache, thereby relinquishing (or releasing) the local memory contribution to the operating system.

Global-cache-accounting function 310 may be responsible for keeping track of the per-node size of the global cache. Such information may be periodically reported to the distributed cache manager, e.g., via cache-manager-interface function 302. In addition, when the global-cache memory manager 300 is queried by a cache manager, global-cache-accounting function 310 may respond to the query. According to alternative aspects, rather than exchanging cache capacity information upon query, each node's cache contribution could be proactively logged as metadata (e.g., part of the cache manager metadata) in a centralized location accessible to the distributed cache manager running on any node, thereby enabling the distributed cache manager instance running on any node to retrieve global cache capacity from all nodes without sending individual queries to each node. In this case, cache-manager-interface function 302 becomes optional.

According to some aspects, the cache manager and global-cache memory manager may be present on each node contributing to the global cache. When the global cache needs additional capacity, the distributed cache manager may select a node currently contributing to the global cache to contribute more of its local storage resources to the global cache. In such a situation, the cache manager running on the selected node may add a portion of the local storage resource to the global cache by creating a global-cache memory manager for the added portion.

Alternatively, the cache manager may select a new node (i.e., a compute node or memory server that does not currently contribute to the global cache). In this situation, a cache manager may need to be created on the selected node before a portion of the local storage resources on the selected node can be added to the global cache. Moreover, a global-cache memory manager may be created on the selected node to manage the portion of the local storage resources contributed to the global cache.

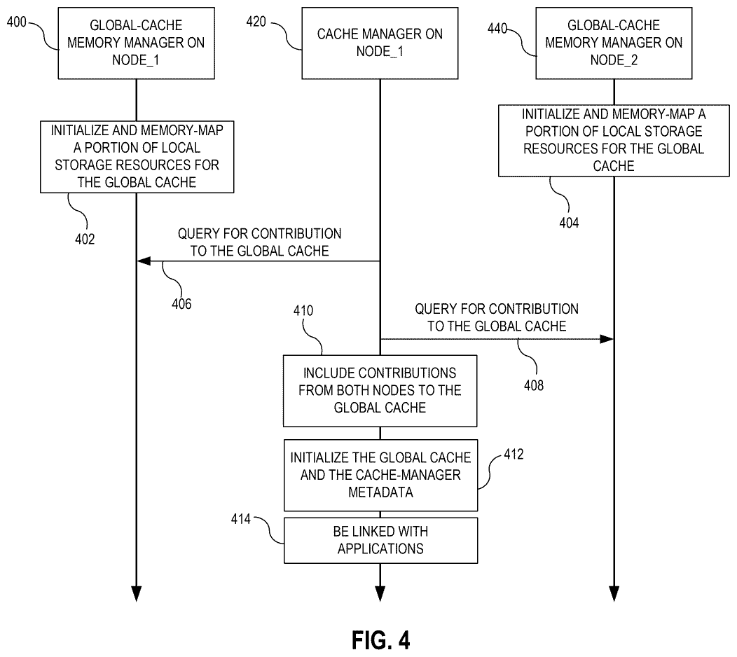

FIG. 4 illustrates a process for initializing a global cache, according to one aspect of the instant application. The global cache may be distributed over a subset of nodes in a computer cluster, with each node in the subset contributing a portion of its local storage resources to the global cache. The global cache may include storage resources organized into multiple tiers (e.g., faster or slower tiers) based on the types of storage resources, including but not limited to DRAM, HBM, SCM, SSD, or any other existing or future memory or storage medium.

During operation, the global-cache memory manager residing on node_1 (i.e., global-cache-memory-manager process 400) may initialize and memory-map a portion of the local storage resources of node_1 for the global cache (operation 402). Node_1 may be a compute node or a memory server in a computer cluster running a plurality of HPC or AI applications. Depending on the use case and availability, the portion of the local storage resources may belong to any of the multiple memory tiers (e.g., DRAM, SSD, SCM, or HBM). Initializing the portion of the local storage resources may involve setting the values of the memory cells to known values. Memory-mapping the portion of the local storage resources may involve mapping the physical addresses of the portion to the virtual address space of the cache-manager process running on the node (i.e., cache-manager process 420), allowing the cache-manager process to use the portion for the global cache. Similarly, the global-cache memory manager residing on node_2 (i.e., global-cache-memory-manager process 440) may initialize and memory-map a portion of the local storage resources of node_2 for the global cache (operation 404).

The cache manager on node_1 (i.e., cache-manager process 420) may query the global-cache memory manager on node_1 for information regarding the contribution from node_1 to the global cache (operation 406) and may query the global-cache memory manager on node_2 for information regarding the contribution from node_2 to the global cache (operation 408). Through these queries, the cache manager on node_1 may obtain address and size information associated with the global cache.

The cache manager on node_1 may include the contributions from both nodes in the global cache (operation 410) and initialize the global cache and the cache-manager metadata (operation 412). Initializing the cache may involve obtaining various cache configuration parameters. The cache-manager metadata may be stored at a shared location accessible to cache-manager processes running on other nodes within the computer cluster.

The cache manager on node_1 may link with applications running on the computer cluster (operation 414). The applications may use a special API to access the cache manager. Once linked, the applications may start using the global cache to cache application data. In the example shown in FIG. 4, there are two nodes (node_1 and node_2) contributing to the global cache. In practice, any number of nodes in the cluster may contribute to the global cache.

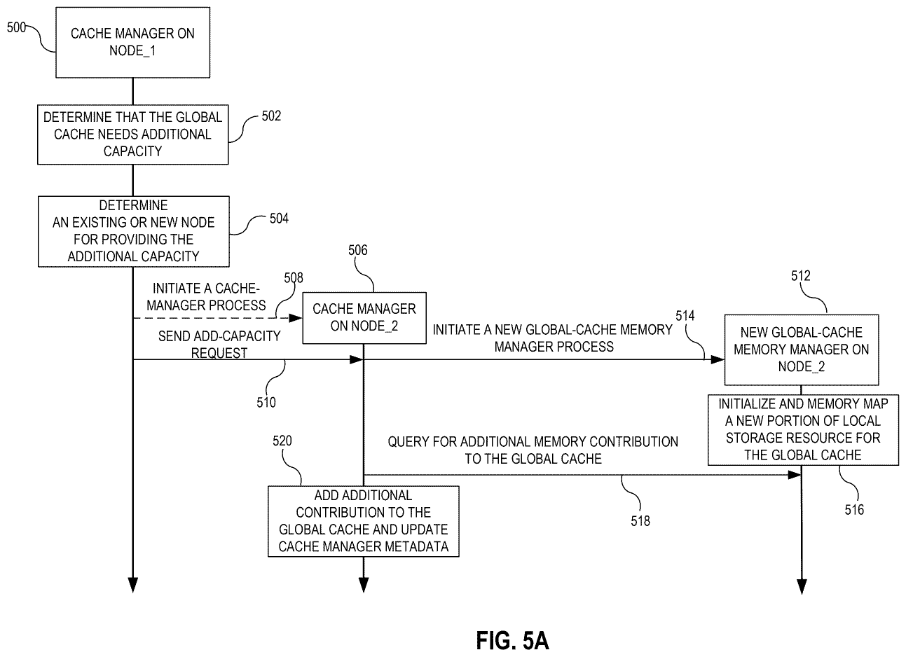

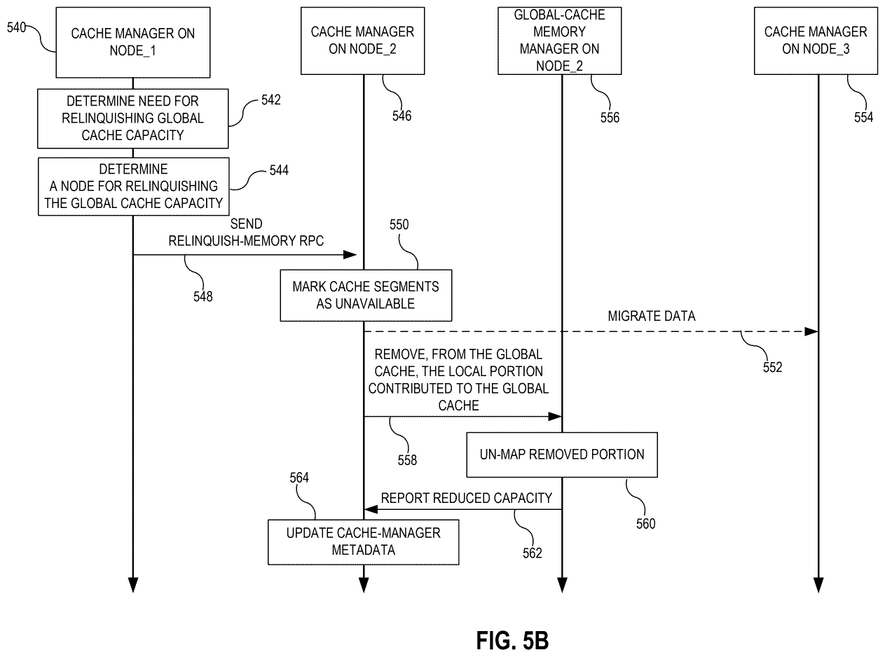

FIG. 5A illustrates a process for increasing the capacity of a global cache, according to one aspect of the instant application. During operation, the cache manager on node_1 (i.e., cache-manager process 500) may determine that the global cache needs additional capacity (operation 502). In some examples, the cache manager may monitor the usage of the global cache and determine that more capacity is needed if the cache-miss rate exceeds a predetermined high-water mark miss-rate threshold, which may be user-configurable. In some examples, this high-water mark miss-rate threshold may be set to 30%, such that additional capacity will be allocated if the cache-miss rate exceeds 30%. Alternatively, the high-water mark miss-rate threshold may be set to 50%.

As discussed previously, the global cache may include multiple tiers of storage resources, including but not limited to DRAM, HBM, SCM, SSD, or any other form of existing or future computer-readable storage medium. When determining that the global cache needs additional capacity, the cache manager may also determine that a specific tier requires the additional capacity by determining whether the cache-miss rate for that specific tier surpasses the predetermined high-water mark miss-rate threshold.

The cache manager on node_1 may determine a node within the cluster that can provide additional capacity to the global cache (operation 504). The node may be one that is already contributing to the global cache or a new node. The determination may be based on the available storage resources (including the available capacity for each tier) and the current load on each node. According to some aspects, the cache manager may apply various resource-allocation algorithms to determine the appropriate node for providing the additional capacity, including but not limited to: round-robin allocation, load-based allocation (e.g., selecting the least-loaded node), weighted allocation (e.g., selecting a node based on a weight function), threshold-based allocation, and dynamic load-balancing allocation.

If the determined node (denoted as node_2) is a new node (i.e., a node that is not currently contributing to the global cache), the cache manager on node_1 may initiate a cache-manager process (i.e., cache-manager process 506) on the new node (operation 508). If the determined node is currently contributing to the global cache, then operation 508 is skipped, as the node is already running a cache-manager process.

The cache manager on node_1 (i.e., process 500) may send an add-capacity request to the cache manager on node_2 (i.e., process 510). The add-capacity request may specify the particular tier needing the additional capacity and the amount of the needed capacity. In response to the request, the cache manager on node_2 may initiate a new global-cache memory manager process (i.e., process 512) on node_2 (operation 514). Note that node_2 may already have a global-cache-memory-management process running to manage the portion that is currently contributed to the global cache. This new process is used to manage the portion to be contributed to the global cache. This new global-cache memory manager may then initialize and memory-map a new portion of the local storage resource on node_2 for the global cache (operation 516). For example, the new global-cache memory manager may use the mmap function to map this new portion on a tmpfs file system to allow the cache-manager process to access this new portion of the local storage resource. Tmpfs is a file system that keeps all files in virtual memory, providing fast access and dynamic sizing, but all data is temporary and lost upon unmount or reboot.

The cache manager on node_2 may query the new global-cache memory manager on node_2 for information about the additional memory contribution to the global cache (operation 518). More specifically, the cache manager on node_2 may obtain the address and size information associated with this newly contributed portion. The cache manager on node_2 may then add this additional contribution to the global cache and update the cache-manager metadata (operation 520). The cache-manager metadata may be accessible to all cache-manager processes, including the cache-manager process running on node_1.

In the example shown in FIG. 5A, the additional capacity of the global cache comes from a single node. In practice, it is also possible to increase the capacity of the global cache by requesting more than one node to contribute additional capacity to the global cache.

FIG. 5B illustrates a process for decreasing the capacity of a global cache, according to one aspect of the instant application. During operation, the cache manager on node_1 (i.e., cache-manager process 540) may determine a need to relinquish global cache capacity (operation 542). The cache manager may monitor the usage of the global cache and determine that not all current capacity is needed if the cache-miss rate falls below a predetermined low-water mark miss-rate threshold or if the interval between consecutive cache misses exceeds a predetermined miss-interval threshold. These thresholds can be user configurable. For example, the low-water mark cache-miss rate threshold may be set to 10%, such that a portion of the global cache capacity is released when the cache-miss rate falls below 10%. In another example, the miss-interval threshold may be set to 100 clock cycles, such that a portion of the global cache capacity may be released when the time interval between consecutive cache misses is greater than 100 clock cycles. In alternative examples, the cache-manager process may provide a configuration parameter or an API that allows external instructions (e.g., from the management platform of the cluster) to request the release of a portion of the global cache capacity.

The cache manager on node_1 may determine a node from which to relinquish global cache capacity (operation 544). The cache manager may identify which node has unused or underutilized global cache capacity that can be released based on the monitored cache usage. For example, the cache manager on node_1 may determine that a portion of the contribution from node_2 to the global cache is unused or underutilized when cache read/write operations targeting node_2 occur at a frequency below a user-configurable cache-access threshold.

The cache manager on node_1 may send a relinquish-memory remote procedure call (RPC) to the cache manager on node_2 (i.e., cache-manager process 546) (operation 548). The RPC may include parameters such as the size of the memory portion to be relinquished. The RPC may cause the cache manager on node_2 to perform a sequence of operations resulting in the release of the specified amount of memory contributed to the global cache by node_2.

Responsive to the RPC, the cache manager on node_2 may mark the affected cache blocks or segments as unavailable (operation 550). For example, the cache manager may modify the metadata of any existing cache blocks in the portion of memory to be released to indicate that they are not available for read or write. The cache manager on node_2 may optionally migrate the data to a different node (e.g., node_3) that has a portion of the global cache (operation 552) by communicating with the cache manager on that node (i.e., cache-manager process 554).

The cache manager on node_2 (i.e., process 546) may then notify the global-cache memory manager on node_2 (i.e., process 556) to remove the local portion contributed to the global cache (operation 558). Accordingly, the global-cache memory manager on node_2 may unmap the removed portion (operation 560). The memory unmap operation relinquishes that portion of memory to the operating system of node_2, allowing the operating system to use that memory for other purposes.

The global-cache memory manager on node_2 may report the reduced capacity to the cache manager on node_2 (operation 562). Accordingly, the cache manager on node_2 may update the cache-manager metadata (operation 564). The cache-manager metadata may be accessible to all cache-manager processes, including the cache-manager process running on node_1.

In some examples, the entire portion contributed to the global cache from one node may be released (i.e., the node is no longer part of the global cache). In such cases, the cache-manager and global-cache-memory-manager processes running on that node may be terminated. In alternative examples, only part of the contributed portion is released from the global cache, meaning that the node is now contributing a smaller portion of its local storage resources to the global cache. In such cases, a new global-cache-memory-manager process may be created to manage this smaller portion.

In some cases, the cluster may experience node failure, or a node in the cluster may be removed. If the failed or removed node is currently contributing to the global cache, the system may need to release the portion of the global cache contributed by the failed or to-be-removed node using a process similar to the one shown in FIG. 5B.

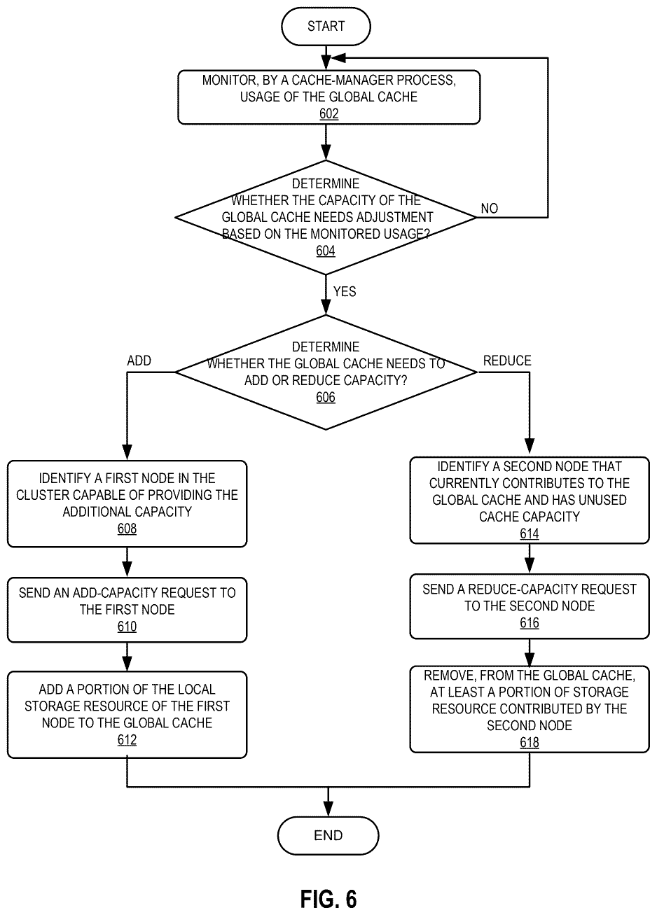

FIG. 6 presents a flowchart illustrating an example process for modifying the capacity of a global cache, according to one aspect of the instant application.

During operation, a cache-manager process may monitor the usage of the global cache (operation 602). The cache-manager process may be a distributed process running on each node contributing to the global cache. For a multi-tiered global cache, the cache-manager process may monitor the cache usage of each tier.

The cache-manager process may determine whether the capacity of the global cache needs adjustment based on the monitored usage (operation 604). The cache-manager process may monitor the number of cache hits and misses on each tier of the global cache and determine whether a specific tier requires a capacity adjustment.

The cache-manager process may further determine whether the global cache needs to add or reduce capacity (operation 606). In one example, if the cache-miss rate exceeds a predetermined high-water mark miss-rate threshold (e.g., 30%), the cache-manager process may determine that the global cache needs to add capacity. In contrast, if the cache-miss rate falls below a predetermined low-water mark miss-rate threshold (e.g., 10%), the cache-manager process may determine that the global cache has unused capacity that can be released. Additionally, if the interval between consecutive cache misses exceeds a predetermined miss-interval threshold (e.g., 100 clock cycles), the cache-manager process may determine that the global cache can reduce capacity.

In response to determining that the global cache needs additional capacity, the cache-manager process may identify a first node in the cluster capable of providing the additional capacity (operation 608). The determination may be based on the available storage resources and current load on each node.

The cache-manager process may send an add-capacity request to the first node (operation 610). The add-capacity request may specify a particular tier needing the additional capacity and the amount of needed capacity. If the identified first node is currently contributing to the global cache (meaning it is already running a cache-manager process), the add-capacity request may be communicated to the cache-manager process on the first node. If the identified first node is a new node that is not yet part of the global cache, a cache-manager process may be initiated on the new node.

The cache-manager process may then add a portion of the local storage resource of the first node to the global cache (operation 612). More specifically, the cache-manager process may communicate with a global-cache-memory-manager process running on the first node, which is responsible for allocating a portion of the local storage of the first node to the global cache. For example, the global-cache-memory-manager process may map the physical address of the added portion of the local storage to the virtual address space of the cache-manager process, allowing the cache-manager process to access the added portion. In a further example, the global-cache-memory-manager process may memory-map the added portion onto a temporary file system.

In response to determining that the global cache needs to reduce capacity, the cache-manager process may identify a second node in the cluster that currently contributes to the global cache and has unused cache capacity (operation 614). For example, the cache-manager process may determine that a global cache portion contributed by a particular node is unused or underutilized based on cache hits at that portion.

The cache-manager process may send a reduce-capacity request to the second node (operation 616). In some examples, the reduce-capacity request may include an RPC that causes the second node to execute a sequence of operations. The reduce-capacity request may specify the amount of cache capacity to be released.

The cache-manager process may then remove at least a portion of the local storage resource contributed by the second node from the global cache (operation 618). More specifically, a global-cache-memory-manage process running on the second node may unmap the portion of the local storage resource to relinquish it to the operating system.

All or any portion of the operations shown in FIG. 6 may be performed, for example, by the various functions illustrated in FIGS. 2 and 3. Although the example process in FIG. 6 shows a specific order for performing certain operations, the process is not limited to this order. Operations shown in succession in a flowchart may be performed in a different order, and may be executed concurrently, partially concurrently, or in combinations thereof.

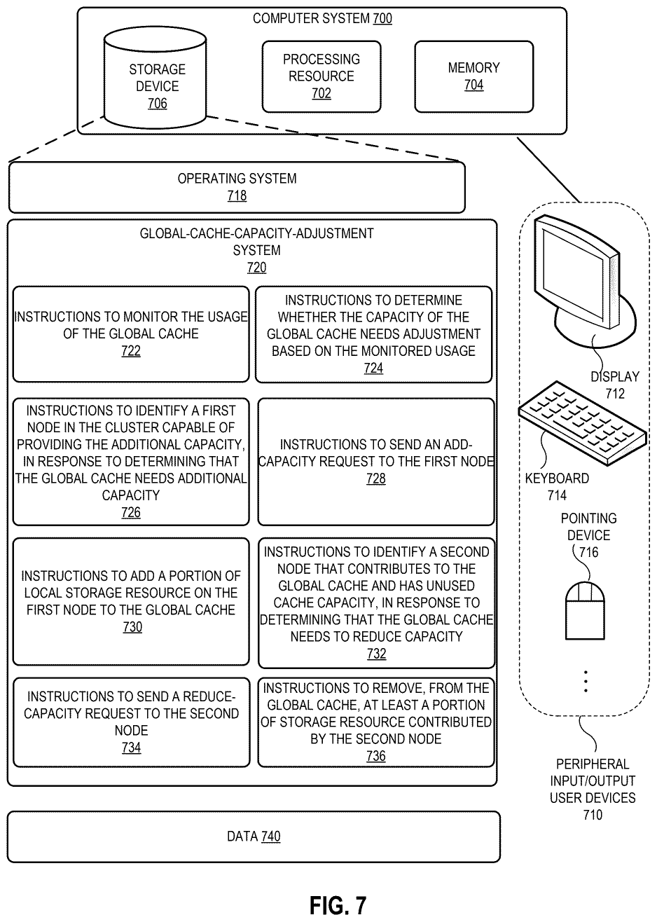

FIG. 7 illustrates a computer system for facilitating the dynamic adjustment of the global cache capacity, according to one aspect of the instant disclosure. Computer system 700 includes a processing resource 702, a memory 704, and a storage device 706. A portion of memory 704 and/or storage device 706 may contribute to the multi-tiered global cache. Furthermore, computer system 700 may be coupled to peripheral I/O user devices 710 (e.g., a display device 712, a keyboard 714, and a pointing device 716). Storage device 706 includes a non-transitory computer-readable storage medium and stores an operating system 718, a global-cache-capacity-adjustment system 720, and data 740. According to some aspects, computer system 700 may be implemented on a node among a plurality of nodes in a computer cluster, such as compute node 102 or 104, or memory server 106 or 108 shown in FIG. 1. Computer system 700 may include fewer or more entities than those shown in FIG. 7.

Global-cache-capacity-adjustment system 720 may include any number of software units, hardware units, and firmware units that work together to achieve the goal of implementing a distributed multi-tiered global cache on the client side. According to some aspects, global-cache-capacity-adjustment system 720 may include instructions that when executed by processing resource 702 may cause processing resource 702 to perform methods and/or processes described in this disclosure.

According to some aspects, global-cache-capacity-adjustment system 720 may include instructions 722 to monitor the usage of the global cache, as described above in relation to operation 602 shown in FIG. 6. The global cache is a distributed cache comprising portions of local storage resources contributed by a subset of nodes in the cluster. The global cache may include different types of computer-readable media organized into multiple tiers, including but not limited to DRAM, HBM, SCM, SSD, or any other form of existing or future computer-readable storage medium. Instructions 722 may include instructions to monitor the cache usage of each tier.

Global-cache-capacity-adjustment system 720 may include instructions 724 to determine whether the capacity of the global cache needs adjustment based on the monitored usage, as described above in relation to operation 604 shown in FIG. 6. More specifically, instructions 724 may include instructions to determine that the global cache needs to add capacity if the cache-miss rate exceeds a predetermined threshold. Instructions 724 may also include instructions to determine that the global cache has unused capacity that can be released if the interval between consecutive cache misses exceeds a predetermined threshold.

Global-cache-capacity-adjustment system 720 may include instructions 726 to identify a first node in the cluster capable of providing the additional capacity, in response to determining that the global cache needs additional capacity, as described in relation to operation 608 shown in FIG. 6. Instructions 726 may include instructions to apply a resource-allocation algorithm to determine the appropriate node for providing the additional capacity based on the available storage resources and current load on each node.

Global-cache-capacity-adjustment system 720 may include instructions 728 to send an add-capacity request to the first node, as described above in relation to operation 610 shown in FIG. 6. The add-capacity request may specify a particular tier needing the additional capacity and the amount of needed capacity. Instructions 728 may include instructions to initiate a cache-manager process on a node that was not part of the global cache and instructions to initiate a global-cache-memory-manager process to manage the to-be-added cache portion.

Global-cache-capacity-adjustment system 720 may include instructions 730 to add a portion of the local storage resource on the first node to the global cache, as described above in relation to operation 612 shown in FIG. 6. More specifically, instructions 730 include instructions to memory-map the added portion onto a temporary file system to allow the cache-manager process to access the added portion.

Global-cache-capacity-adjustment system 720 may include instructions 732 to identify a second node that contributes to the global cache and has unused cache capacity, as described in relation to operation 614 shown in FIG. 6. The cache-manager process may determine that the global cache portion contributed by a particular node is unused or underutilized based on intervals between consecutive cache hits at that portion.

Global-cache-capacity-adjustment system 720 may include instructions 734 to send a reduce-capacity request to the second node, as described above in relation to operation 616 shown in FIG. 6. Instructions 734 may include instructions to revoke an RPC.

Global-cache-capacity-adjustment system 720 may include instructions 736 to remove, from the global cache, at least a portion of the storage resource contributed by the second node, as described above in relation to operation 616 shown in FIG. 6. Instructions 736 may include instructions to unmap the removed portion to relinquish it to the operating system running on the second node.

Global-cache-capacity-adjustment system 720 may include more instructions than those shown in FIG. 7. For example, global-cache-capacity-adjustment system 720 may include instructions to update the cache-manager metadata after modifying the capacity of the global cache.

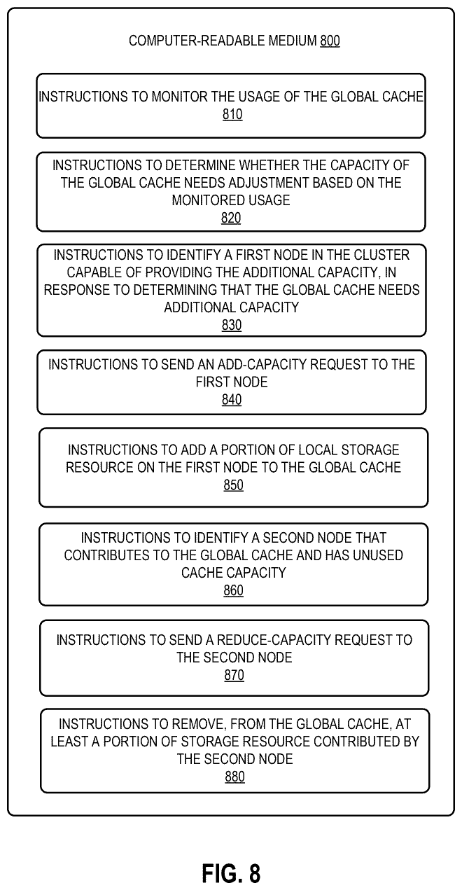

FIG. 8 illustrates a computer-readable medium (CRM) that facilitates dynamic adjustment of the global cache capacity, according to one aspect of the instant disclosure. CRM 800 may be a non-transitory computer-readable medium or device storing instructions that when executed by a computer or processing resource cause the computer or processing resource to perform a method.

CRM 800 may store instructions 810 to monitor the usage of the global cache, as described above in relation to operation 602 shown in FIG. 6; instructions 820 to determine whether the capacity of the global cache needs adjustment based on the monitored usage, as described above in relation to operation 604 shown in FIG. 6; instructions 830 to identify a first node in the cluster capable of providing the additional capacity, in response to determining that the global cache needs additional capacity, as described in relation to operation 608 shown in FIG. 6; instructions 840 to send an add-capacity request to the first node, as described above in relation to operation 610 shown in FIG. 6; instructions 850 to add a portion of the local storage resource on the first node to the global cache, as described above in relation to operation 612 shown in FIG. 6; instructions 860 to identify a second node that contributes to the global cache and has unused cache capacity, as described in relation to operation 614 shown in FIG. 6; instructions 870 to send a reduce-capacity request to the second node, as described above in relation to operation 616 shown in FIG. 6; and instructions 880 to remove, from the global cache, at least a portion of the storage resource contributed by the second node, as described above in relation to operation 616 shown in FIG. 6.

CRM 800 may include more instructions than those shown in FIG. 8. For example, CRM 800 may include instructions to update the cache-manager metadata after modifying the capacity of the global cache.

In general, the disclosure provides a global client-side cache system that can dynamically change the cache capacity based on the changing needs of the applications. The global cache may be shared among a plurality of applications running on a cluster of compute and storage nodes. A node contributing its local storage resources (e.g., DRAM or SSD) to the global cache runs a global-cache memory manager that manages its contribution to the global cache. A distributed cache manager running on the cluster may monitor applications' cache usage to increase or reduce the capacity of the global cache accordingly. To increase the cache capacity, the cache manager may create a new global cache memory manager on an existing memory-contributing node or a new node. This newly created global-cache memory manager may initialize and memory-map a local memory/storage portion and communicate with a local cache-manager process to add the local memory/storage portion to the global cache. To reduce the cache capacity from a particular node, the cache manager may send an RPC call to the node, causing the global-cache-memory-manager process on that node to unmap a portion or the entirety of its contribution to the global cache. After modification to the global cache capacity, the cache manager may update the cache-manager metadata.

In the examples described herein, functionalities described as being performed by “instructions” may be understood as functionalities that may be performed by those instructions when executed by a processing resource. In other examples, functionalities described in relation to instructions may be implemented by one or more logic units, which may be any combination of hardware and programming to implement the functionalities of the logic unit(s).

One aspect of the instant disclosure provides a system and a method for dynamically adjusting the capacity of a distributed global cache in a computer cluster. During operation, a cache-manager process running on a respective node of the computer cluster may monitor the usage of the global cache and determine whether the capacity of the global cache needs adjustment based on the monitored usage. In response to determining that the global cache needs additional capacity, the system may identify a first node in the computer cluster capable of providing the additional capacity, send an add-capacity request to the first node, and add a portion of storage resource on the first node to the global cache. In response to determining that the global cache needs to reduce capacity, the system may identify a second node that contributes to the global cache, send a reduce-capacity request to the second node, and remove, from the global cache, at least a portion of storage resource contributed by the second node.

According to one variation on this aspect, the global cache may include storage resources contributed by a subset of nodes in the computer cluster, and the storage resources are grouped into multiple tiers.

According to a further variation, determining that the global cache needs additional capacity may include determining that a specific tier of the storage resources needs additional capacity.

According to a further variation, the add-capacity request may indicate the specific tier of the storage resources to which the first node is to contribute.

According to a further variation, the first node is not within the subset of nodes currently contributing to the global cache. The system may initiate a cache-manager process on the first node.

According to one variation on this aspect, sending the add-capacity request may include initiating a global-cache-memory-manager process on the first node and instructing the global-cache-memory-manager process to allocate the portion of the storage resource on the first node to the global cache and memory-map the allocated portion onto a temporary file system.

According to a further variation, the global-cache-memory-manager process may communicate information associated with the allocated portion of the storage resource to a cache-manager process running on the first node, and the cache-manager process running on the first node may update cache manager metadata based on the adjusted capacity of the global cache.

According to one variation on this aspect, sending the reduce-capacity request may include sending a remote procedure call (RPC) to the second node.

According to a further variation, responsive to the RPC, a cache-manager process running on the second node may mark cache blocks in the to-be-removed portion of the global cache as unavailable, and a global-cache-memory-manager process running on the second node may unmap the to-be-removed portion of the global cache.

According to a further variation, responsive to the RPC, the cache-manager process running on the second node may migrate data from the to-be-removed portion of the global cache to a different node.

One aspect of the instant disclosure provides a cache system for a computer cluster comprising a plurality of nodes. The cache system includes a global cache distributed over a subset of nodes of the computer cluster, a respective node in the subset contributing a portion of local storage resource to the global cache and running a cache-manager process to monitor usage of the global cache and determine whether capacity of the global cache needs adjustment based on the monitored usage. In response to determining that the global cache needs additional storage capacity, the cache-manager process may identify a first node in the computer cluster capable of providing the additional storage capacity, send an add-capacity request to the first node, and add a portion of storage resource on the first node to the global cache. In response to determining that the global cache needs to reduce storage capacity, the cache-manager process may identify a second node that contributes to the global cache, send a reduce-capacity request to the second node, and remove, from the global cache, at least a portion of storage resource contributed by the second node.

One aspect of the instant disclosure provides a non-transitory computer-readable storage medium storing instructions which when executed by a processor cause the processor to perform a method for dynamically adjusting the capacity of a distributed global cache in a computer cluster. The method includes: monitoring, by a cache-manager process running on a respective node of the computer cluster, usage of the global cache and determining whether the capacity of the global cache needs adjustment based on the monitored usage. The method includes: in response to determining that the global cache needs additional capacity, identifying a first node in the computer cluster capable of providing the additional capacity; sending an add-capacity request to the first node; and adding a portion of storage resource on the first node to the global cache. The method further includes: in response to determining that the global cache needs to reduce capacity, identifying a second node that contributes to the global cache; sending a reduce-capacity request to the second node; and removing, from the global cache, at least a portion of storage resource contributed by the second node.

In the examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

As used herein, the term “node” may refer to one or more computing devices configured to provide the functions described herein. A “computing device” may be a server, a cluster of servers, a storage array, a computer appliance, a workstation, a desktop computer, a laptop computer, a switch, a router, or any other processing device or equipment including a processing resource. A node may include a processing resource communicatively coupled to at least one non-transitory computer-readable storage medium including instructions that, when executed by the processing resource, cause the node to undertake certain actions and functionalities as described herein.

As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatuses. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method for dynamically adjusting capacity of a distributed global cache in a computer cluster, the method comprising:
monitoring, by a cache-manager process running on a respective node of the computer cluster, usage of the global cache;
determining whether capacity of the global cache needs adjustment based on the monitored usage;
in response to determining that the global cache needs additional capacity,
identifying a first node in the computer cluster capable of providing the 8 additional capacity;
sending an add-capacity request to the first node; and
adding a portion of storage resource on the first node to the global cache; and
in response to determining that the global cache needs to reduce capacity,
identifying a second node that contributes to the global cache;
sending a reduce-capacity request to the second node; and
removing, from the global cache, at least a portion of storage resource contributed by the second node.

2. The method of claim 1, wherein the global cache comprises storage resources contributed by a subset of nodes in the computer cluster, and wherein the storage resources are grouped into multiple tiers.

3. The method of claim 2, wherein determining that the global cache needs additional capacity comprises determining that a specific tier of the storage resources needs additional capacity.

4. The method of claim 3, wherein the add-capacity request indicates the specific tier of the of storage resources to which the first node is to contribute.

5. The method of claim 2, wherein the first node is not within the subset of nodes currently contributing to the global cache, and wherein the method further comprises initiating a cache-manager process on the first node.

6. The method of claim 1, wherein sending the add-capacity request comprises initiating a global-cache-memory-manager process on the first node and instructing the global-cache-memory-manager process to:
allocate the portion of storage resource on the first node to the global cache; and
memory-map the allocated portion onto a temporary file system.

7. The method of claim 6, further comprising:
communicating, by the global-cache-memory-manager process, information associated with the allocated portion of storage resource to a cache-manager process running on the first node; and
updating, by the cache-manager process running on the first node, cache manager metadata based on the adjusted capacity of the global cache.

8. The method of claim 1, wherein sending the reduce-capacity request comprises sending a remote procedure call (RPC) to the second node.

9. The method of claim 8, wherein, in response to the RPC, the method further comprises:
marking, by a cache-manager process running on the second node, cache blocks in the to-be-removed portion of the global cache as unavailable; and
unmapping, by a global-cache-memory-manager process running on the second node, the to-be-removed portion of the global cache.

10. The method of claim 9, wherein, in response to the RPC, the method further comprises:
migrating, by the cache-manager process running on the second node, data from the to-be-removed portion of the global cache to a different node.

11. A cache system for a computer cluster comprising a plurality of nodes, the cache system comprising:
a global cache distributed over a subset of nodes of the computer cluster, a respective node in the subset contributing a portion of local storage resource to the global cache and running a cache-manager process to:
monitor usage of the global cache;
determine whether capacity of the global cache needs adjustment based on the monitored usage;
in response to determining that the global cache needs additional storage capacity,
identify a first node in the computer cluster capable of providing the additional storage capacity;
send an add-capacity request to the first node; and
add a portion of storage resource on the first node to the global cache; and
in response to determining that the global cache needs to reduce storage capacity,
identify a second node that contributes to the global cache;
send a reduce-capacity request to the second node; and
remove, from the global cache, at least a portion of storage resource contributed by the second node.

12. The cache system of claim 11, wherein storage resources contributed by the subset of nodes in the global cache are grouped into multiple tiers, and wherein the cache-manager process is to determine that a specific tier of the storage resources needs additional capacity.

13. The cache system of claim 12, wherein the add-capacity request indicates the specific tier of the storage resources to which the first node is to contribute.

14. The cache system of claim 11, wherein, while sending the add-capacity request to the first node, the cache-manager process is to initiate a global-cache-memory-manager process on the first node and instruct the global-cache-memory-manager process to:
allocate the portion of storage resource on the first node to the global cache; and
memory-map the allocated portion onto a temporary file system.

15. The cache system of claim 14,
wherein the global-cache-memory-manager process is to communicate information associated with the allocated portion of storage resource to a cache-manager process running on the first node; and
wherein the cache-manager process running on the first node is to update cache manager metadata based on the adjusted capacity of the global cache.

16. The cache system of claim 11, wherein, while sending the reduce-capacity request, the cache-manager process is to send a remote procedure call (RPC) to the second node.

17. The cache system of claim 16, wherein responsive to the RPC:
a cache-manager process running on the second node is to mark cache blocks in the to-be-relinquish portion of the global cache as unavailable; and
a global-cache-memory-manager process running on the second node is to unmap the to-be-removed portion of the global cache.

18. A non-transitory computer-readable storage medium storing instructions which when executed by a processor cause the processor to perform a method for dynamically adjusting capacity of a distributed global cache in a computer cluster, the method comprising:
monitoring, by a cache-manager process running on a respective node of the computer cluster, usage of the global cache;
determining whether capacity of the global cache needs adjustment based on the monitored usage;
in response to determining that the global cache needs additional capacity,
identifying a first node in the computer cluster capable of providing the additional capacity;
sending an add-capacity request to the first node; and
adding a portion of storage resource on the first node to the global cache; and
in response to determining that the global cache needs to reduce capacity,
identifying a second node that contributes to the global cache;
sending a reduce-capacity request to the second node; and
removing, from the global cache, at least a portion of storage resource contributed by the second node.

19. The non-transitory computer-readable storage medium of claim 17,
wherein sending the add-capacity request comprises initiating a global-cache-memory-manager process on the first node and instructing the global-cache-memory-manager process to:
allocate the portion of storage resource on the first node to the global cache; and
memory-map the allocated portion on a temporary file system; and wherein the method further comprises:
communicating, by the global-cache-memory-manager process, information associated with the allocated portion of storage resource to a cache-manager process running on the first node; and
updating, by the cache-manager process running on the first node, cache manager metadata to reflect the adjusted capacity of the global cache.

20. The non-transitory computer-readable storage medium of claim 18:
wherein sending the reduce-capacity request comprises sending a remote procedure call (RPC) to the second node; and
wherein, responsive to the RPC, the method further comprises:
marking, by a cache-manager process running on the second node, cache blocks in the to-be-removed portion of the global cache as unavailable; and
unmapping, by a global-cache-memory-manager process running on the second node, the to-be-removed portion of the global cache.
